(19) United States
(12) Patent Application Publication
(10) Pub. No.: US 2009/0158579 A1
(43) Pub. Date: Jun. 25, 2009

(54) AUTOMATIC SCREWING DEVICE FOR THE CHASSIS OF A MOTOR VEHICLE

(75) Inventors: Salvador Climent, Zaragoza (ES); Franz Sabo, Pfungstadt (DE)

Correspondence Address: INGRASSIA FISHER & LORENZ, P.C. (GME), 7010 E. COCHISE ROAD, SCOTTSDALE, AZ, 85253, US

(73) Assignee: GM GLOBAL TECHNOLOGY OPERATIONS, INC., Detroit, MI (US)

(21) Appl. No.: 12/089,601

(22) PCT Filed: Sep. 28, 2006
(86) PCT No.: PCT/EP2006/009420

§ 371 Date: Oct. 2, 2008

(30) Foreign Application Priority Data
Oct. 8, 2005 (DE) 10 2005 048 278.3

(51) Int. Cl. B23P 11/00

(52) U.S. Cl. 29/525.11; 29/281.5

(57) ABSTRACT

A screw connection station is provided for use with a suspension conveyor with body suspension means for a respective vehicle body and with an assembly device for chassis components to be assembled in the vehicle body. The screw connection station has a running gear with a floating plate which has at least one screw connection device. The screw connection device is divided into a z-linear device, an x-linear device and a y-linear device as well as into one or more screw spindles. A centering-adaptation-displacement unit is provided for temporary connection and referencing between a body suspension means and the floating plate or between an assembly device and the floating plate.

### CROSS-REFERENCE TO RELATED APPLICATIONS

This application is a U.S. National-Stage entry under 35 U.S.C. § 371 based on International Application No. PCT/EP2006/009420, filed Sep. 28, 2006, which was published under PCT Article 21(2) and which claims priority to German Application No. DE 10 2005 048 278.3, filed Oct. 8, 2005, which are all hereby incorporated in their entirety by reference.

### TECHNICAL FIELD

The technical field generally relates to a screw connection station, and more particularly to a screw connection station for the chassis of a motor vehicle.

### BACKGROUND

U.S. Pat. No. 4,086,522 discloses a welding robot, which is used during the so-called “marriage” to connect a chassis to a body.

U.S. Pat. No. 4,928,386 discloses a manufacturing process for assembling chassis components in a body of a motor vehicle, in which the chassis units are arranged on an assembly plate. During assembly, the assembly plate moves with the chassis, the chassis units are raised into their final position and screw connected there.

U.S. Pat. No. 4,734,979 discloses a method of this type, in which a separate assembly plate which is aligned on the suspension conveyor used for transporting the body, is provided in each case for the region of the front axle and the region of the rear axle. In this solution, the screw connection devices are not flexible enough to be able to incorporate product changes of the motor vehicle that are required, at short notice and economically, as changes into the screw connection device.

U.S. Pat. No. 4,589,184 discloses screw connection devices for fastening doors of a motor vehicle which are mounted on linear units. The screw connection devices move on a driven slide next to the body moving in the production line. While the doors of manipulators that are likewise also moving are held in the assembly position, the fastening screws of the doors are tightened by the screw connection devices.

It is explained in JP 2001 120 6263 how a quality control can be carried out during the assembly of motor vehicles.

The invention is based on the object of simplifying the assembly of chassis components and making it more flexible, so that, with the same screw connection station, various types of vehicles can be produced one after the other. In addition, other objects, desirable features and characteristics will become apparent from the subsequent summary, detailed description and appended claims, taken in conjunction with the accompanying drawings and this background.

### SUMMARY

The invention provides a screw connection station for a suspension conveyor with body suspension means in each case for a vehicle body and for an assembly device for chassis components to be mounted in the vehicle body.

The screw connection station has a running gear with a floating plate, the floating plate having at least one screw connection device. The screw connection device is divided into a z-linear device, an x-linear device and a y-linear device as well as into one or more screw spindles.

A centering-adaptation-displacement unit is provided for temporary connection and referencing between a body suspension means and the floating plate or between an assembly device and the floating plate.

The screw connection station according to the invention for a suspension conveyor with body suspension means for a vehicle body in this case has a running gear temporarily also moving with a body suspension means, with a floating plate. The floating plate may have a gantry construction and one or more screw connection devices.

A temporary connection between the floating plate and body suspension means or between the floating plate and assembly plate is produced for referencing the floating plate with the combination of the body suspension means and assembly plate. In an advantageous configuration, an auxiliary construction, for example a gantry construction, is used for temporary connection between the floating plate and body suspension means.

The floating plate optionally has an auxiliary construction, for example a gantry construction for referencing the floating plate with respect to the body suspension means or with respect to the body suspension means foot or to the assembly plates or workpiece carriers.

The screw connection device may also, if necessary, have a screw spindle suspension device, which allows tolerance compensation in the x/y-direction.

An auxiliary construction in the form of an adaptation device or a gantry construction may also be used for temporary connection between the floating plate and a body suspension means or the mounting plates/assembly stand.

A high degree of flexibility is ensured here just as when screwing by hand. No additional setting-up faces need to be provided in contrast to the use of a manipulator as in U.S. Pat. No. 4,589,184. This allows existing production lines to be retrofitted.

The system according to the invention may operate in continuous operation or in a stop-and-go manner of operating. The screw spindles of the automatic screw connection device are preferably assembled on y-NC linear units or on lower units. The screw coordinates of the screwing positions are programmed in and screw points may be added at short notice or erased.

A plurality of screw points may be approached one after the other with the same screw spindle. In addition, a high degree of flexibility of the screw connection device is provided when there are model modifications or there is a change of model. This allows economical solutions when there are modifications to models, additional model variants or a change of model.

The linear units for the automatic screw connection devices may also be integrated into a quality control.

The invention provides a fully automatic screw connection device and a fully automatic assembly method with integrated quality control for fastening chassis units to a body of a motor vehicle in a continuous process or a stop-and-go process. In this case, the fully automatic screw connection device is provided with at least one linear unit and this linear unit is fitted with at least one screw spindle. The screw point coordinates of the screw positions in the fully automatic screw connection device can be programmed freely. Screw coordinates of screw positions can, at short notice, be added, changed, rejected or erased.

A plurality of screw connection points may be approached one after the other at the predetermined cycle time with the same linear unit and screw connected.

According to the evaluation, after the automatic screw connection, a further processing may take place directly following the corresponding manufacturing process. This may comprise the following steps:

detecting the actual values of the screw connection to check and document the screw connection as a quality assurance measure,

further transportation of the body with the connected chassis units and

evaluation of the detected actual values of the screw connection by a desired/actual comparison with the predetermined screw connection desired data as a further quality assurance measure.

The present invention also relates to a fully automatic screw connection station for screw connecting chassis units to a body of a motor vehicle in a continuous process or stop-and-go process. The following steps were carried out beforehand in the “marriage”:

simultaneous supply of the chassis units to the body constantly moved in the continuous process or the body of a motor vehicle moved in stop-and-go operation,

alignment of the chassis units on the constantly moved body or the body moved in stop-and-go operation.

The following steps are carried out by the invention:

screw connecting the chassis units to the moved or non-moved body,

detecting the actual values of the screw connection for checking and documentation of the screw connection as a quality assurance measure,

further transportation of the body with the connected chassis units and

evaluation of the detected actual values of the screw connection by a desired/actual comparison with the predetermined screw connection desired data as a further quality assurance measure.

Assembly methods and screw connection devices of this type may be used at all series or mass production sites, which produce modularly constructed products by continuous processes or stop-and-go processes, in particular in automobile manufacturing.

For this purpose, base parts and components or units to be attached to the base part are transported to a joining location, where the base part and the components are joined by means of suitable connections or connection elements.

When supplying the body and body parts by means of conveying devices, the chassis units may be manually connected to the body by correspondingly trained operators, who align the chassis units with the body by means of alignment units to be actuated and then connect them manually (“marriage”).

Screw connection devices are used for the mechanical connection of the body and body parts or chassis units, decoupling of the chassis parts and the body from the continuous process no longer being necessary with these screw connection devices, in order to be able to connect the chassis units to the body. After the chassis units and body have been fastened, the body does not need to be coupled into the continuous process again. A quality assurance does not need to take place only towards the end of the continuous process, the invention makes it possible for any possibly necessary reprocessing to directly follow the quality assurance of the screw connecting step.

The invention relates to a system which operates in continuous operation or with stop-and-go. The screw spindles of the automatic screw connection device are mounted on linear units, such as are known, for example, from U.S. Pat. No. 4,589,184. The screw coordinates of the screw points are programmed in. Screw points can be added or erased at short notice. A plurality of screw points may be approached one after the other with the same screw spindle. The use of linear units allows an economical solution to the problems.

With the basic idea of the invention, a maximum flexibility of the automatic screw connection operations can be achieved. Retaining the continuous production with a given peripheral assembly line and body suspension means is possible.

The invention provides a fully automatic screw connection device, which is distinguished by the highest flexibility when the screw spindles approach the respective screw points on the motor vehicle. This flexibility is desired during model modifications, a change of model and additional model variants, it being possible to freely programme in the screw coordinates of the screw points in the screw connection device. The invention works in continuous operation or with stop-and-go operation, without the need for decoupling and stopping the body when fastening the chassis units and body during the continuous process. The quality assurance is carried out in real time during the continuous production. The assembly method is carried out automatically. According to the evaluation, a reprocessing takes place directly following the corresponding production process in the continuous process or during the stop-and-go process.

The screw connection according to the invention, in contrast to a manual screw connection operation, is very rarely faulty and can always be reproduced with the required reliability. If a faulty screw connection operation takes place, this is detected while it has not yet led to a critical situation. The automatic screw connection process is monitored during the screw connection process, specifically for the angle of rotation and trueness of the torque. If there are deviations, the screw connection process is interrupted with a warning signal. This ensures that such a car does not leave production.

An advantageous configuration of the invention, after the alignment of the chassis units with the body, provides that the step of the screw spindles with programmable linear units approaching the screw points comprises the following steps:

detection of the disposition and location of the body or the body suspension means or

detection of the disposition and location of the mounting plate-assembly stand,

start and synchronous travel of a screw connection device with a body suspension means, mounting plate-assembly stand and detection of the existing screwing situation.

Freely programmable NC-linear units allow maximum flexibility of the screw connection device. Screw coordinates can also be added, changed or erased at short notice from screw points. A plurality of screw points can be approached one after the other with the same screw spindle and screw connected.

A body is conveyed to the assembly station by means of a continuous conveyor or stop-and-go conveyor configured as a suspension conveyor.

A second continuous conveyor or stop-and-go conveyor, which is arranged at the bottom, conveys a mounting plate-assembly stand, on which chassis units are arranged which have been connected beforehand in the “marriage” region to the body.

This mounting plate-assembly stand is connected to the body by means of a coupling mechanism, so that the body and chassis units are moved equally.

The body is transported in this case by means of a body suspension means, which is in turn moved by the first continuous conveyor or stop-and-go conveyor, which is configured as a suspension conveyor.

The mounting plate-assembly stand has an assembly stand, on which assembly plates are located to receive the chassis units. These chassis units are, for example, the rear axle, shock absorber, rear spring, jointed shaft in the case of rear-wheel drive, front axle, suspension struts, steering systems, gear changing systems, or engines.

The chassis units to be screw connected are received located centrally on the assembly plates or mounting plates. The assembly plates are mounted in a floating manner and can be aligned with respect to the body.

Relative movements between the mounting plate-assembly stand and body are compensated by a floating plate construction.

The assembly plates are centred on the vehicle substructure in the centering bores by means of extendable centering cylinders.

The vehicle substructure is automatically locked at the back here at the extended centering cylinders of the mounting plate-rear axle on the suspension foot.

The bolts for the chassis units are preassembled in a setting-up section.

For this purpose, the bolts are received in intermediate spindles in the sockets, and inserted through the chassis units to be screw connected during preassembly.

The sockets are placed on axle-type bolt carriers. The bolt carriers for the vertical screw connections are mounted on the front and rear axle assembly plate.

Linear units are assembled on the left-hand and right-hand displacement unit of the automatic screw connection device, on which linear units there are mounted spindle screw connection devices. The screw point coordinates X, Y, Z to be approached are programmed in for the respective linear units.

The linear units of the automatic screw connection device approach the required screw point coordinates and spindle screw connection devices attach in accordance with the predetermined screw point coordinates, to the lower part of the axle-type bolt carriers.

The spindles of the bolt carriers are mounted in a floating manner and can compensate tolerance deviations.

The fully automatic screw connection device is base-guided and in continuous operation, moves fully automatically, synchronously and in parallel to the body to be screw connected and to the assembly stand and the body suspension means according to specifications.

The common travelling speed of the automatic screw connection device is measured at the body conveyor.

The starting point of the automatic screw connection device is detected or determined by means of a photoelectric barrier.

The present invention relates to a fully automatic screw connection device and a fully automatic assembly method with integrated quality control for fastening chassis units to a body of a motor vehicle in a continuous process or stop-and-go process, the fully automatic screw connection device being provided with at least one linear unit and this linear unit being equipped at least with a screw spindle, wherein the screw point coordinates of the screw points in the fully automatic screw connection device can be freely programmed, and screw coordinates of screw points can be added, changed, deselected or erased at short notice.

A plurality of screw points can be approached one after the other in the predetermined cycle time with the same linear unit and screw connected.

According to the evaluation, after the automatic screw connection operation, a further processing directly follows the corresponding production process with the following steps:

detection of the actual values of the screw connection to check and document the screw connection as a quality assurance measure and

further transportation of the body with the connected chassis units, and evaluation of the detected actual values of the screw connection by a desired/actual comparison with the predetermined screw connection desired data as a further quality assurance measure.

The detection of the actual values and/or the evaluation may be carried out at any time after assembly has taken place.

After the screw connection operation to the chassis units, if there are deviations of the actual values from the desired specifications, the body runs through a re-processing station with a quality control.

The step of simultaneously supplying the chassis units to the body of a motor vehicle which is constantly moved in the continuous process, or not moved, may comprise the following steps:

supplying the chassis unit means using at least one mounting plate-assembly stand,

supplying the body by means of a body suspension means and

passage though a common production site for the “marriage” or for joining chassis units and the body.

The process sequence of the invention comprises the following steps:

detecting the disposition and location of the body or the body suspension means,

detecting the disposition and location of the mounting plate-assembly stand,

start of the synchronous travel of a fully automatic screw connection device with a body suspension means or mounting plate/assembly stand or according to the travel of the body, and

detecting the existing screwing situation.

The step of connecting the chassis units to the body may comprise the following steps:

adjusting the corresponding screw tightening variant,

attaching the screw connection device to the mounting plate-assembly stand or the body suspension means/foot,

automatic mechanical screw connection of the chassis units to the moved or non-moved body.

The step of further transportation of the body with the connected chassis units may comprise the following steps:

disconnecting the screw connection device,

guiding away the mounting plate-assembly stand,

further transportation of the body and

displaying the detected actual values of the screw connection operation.

The step of evaluating the detected actual values of the screw connections by a desired/actual value comparison with the predetermined screw connection desired data may comprise the following steps:

desired/actual comparison of the installation situation,

storage of the evaluation and the detected values,

setting up a report about the evaluation of the screw connection data and

forwarding the data.

The fully automatic screw connection device according to the invention with integrated quality control after the marriage in a continuous operation or in stop-and-go operation for producing motor vehicles has means for carrying out these method steps.

The means comprise at least one linear unit and a screw spindle attached thereto, wherein the screw point coordinates of the screw points can be freely programmed in the fully automatic screw connection device, and screw coordinates of screw points can be added, changed, deselected or erased at short notice.

The means also comprise at least one mounting-assembly stand and at least one continuous conveyor in order to simultaneously supply the chassis units to the body moved in the continuous process or the stop-and-go process.

The means also comprise at least one coupling mechanism to align the chassis units to the moved or non-moved body.

In addition, at least one sensor and a computing unit are provided to detect the actual values of the screw connections, to check them and document them and thus to ensure the quality of the screw connections.

A continuous conveyor configured as a body suspension means, or a stop-and-go conveyor is provided to convey the body. A control loop carries out a desired/actual comparison of the detected actual values of the screw connection and the predetermined desired values of the screw connection.

A reprocessing station also provided is coupled to the screw connection station.

Screw connections with different widths across flats and torques can be screw connected with a screwing unit or a screw spindle, as the different screw connections are equipped with separate axle-type bolt carriers or intermediate spindles on the assembly plates. These axle-type bolt carriers or intermediate spindles, on the lower side, i.e. on the interface to the screw spindle, have a uniform coupling connection, for example hexagon, torx, etc.

With different widths across flats of the screw connections, separate screw spindles can be provided for each screwing unit. For this purpose, an intermediate spindle is provided on the assembly plates for each screw connection. Thus, there is then a magazine of a plurality of intermediate spindles optionally with different widths across flats. Each intermediate spindle has a unified width across flats from below. When simple vertical screw connection operations are carried out, no additional tightening or counter support mechanisms need to be provided.

Tightening or counter support mechanisms can be provided for tie rods or transverse links.

The present system of continuous production, assembly line, assembly stand and assembly plates can easily be retrofitted with the invention including the intermediate spindles provided in between.

The invention has four screwing units per vehicle side, each screwing unit being able to have one or more EC screwing spindles each. As required, more or fewer screwing units may be used. Such EC screwing spindles are offered, for example, by Bosch-Rexroth. Within a cycle time of 60 seconds, each of the screwing spindles should carry out three to four screw connection operations. The existing process sequence with peripheral interfaces thus remains unchanged. Axle journal screwing connections, such as link supports and transverse links, can be shifted into other assembly regions because these may require additional tightening and counter support mechanisms. This can increase the flexibility of the invention.

The invention is successful for vertical screw connection operations, in particular. For horizontal or oblique connections, actuating elements which can be inclined at an angle, for example mini-manipulators, may be provided in addition to the linear guides. This is successful in particular for screwing shock absorbers. The screw spindles can be mounted in a floating manner for tolerance compensation.

A linear unit is divided into a guide unit and a drive unit.

According to the invention, mechanisms for tolerance compensation are also provided. A centred tolerance compensation is provided for the floating plate in the x-direction with regard to the line speed in the x-direction in order to compensate both the conveying speeds of the conveyors for the body suspension means and for the assembly stand/mounting plates and also acceleration and retarding speeds of the two conveyors.

Moreover, the screw spindles may be equipped with an additional tolerance compensation construction.

### BRIEF DESCRIPTION OF THE DRAWINGS

The present invention will hereinafter be described in conjunction with the following drawing figures, wherein like numerals denote like elements, and.

FIG. 1 shows a schematic view of the screw connection device according to the invention from the front;

FIG. 2 shows a schematic side view of the screw connection device from FIG. 1;

FIG. 3 shows a schematic view of the screw connection device from FIG. 1 from above;

FIG. 4 shows a detail of the tolerance compensation in a floating plate of the screw connection device from FIGS. 1 to 3; and

FIG. 5 shows a detail of the positioning of the floating plate by means of a gantry or auxiliary device for the suspension foot of the screw connection device from FIGS. 1 to 3.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

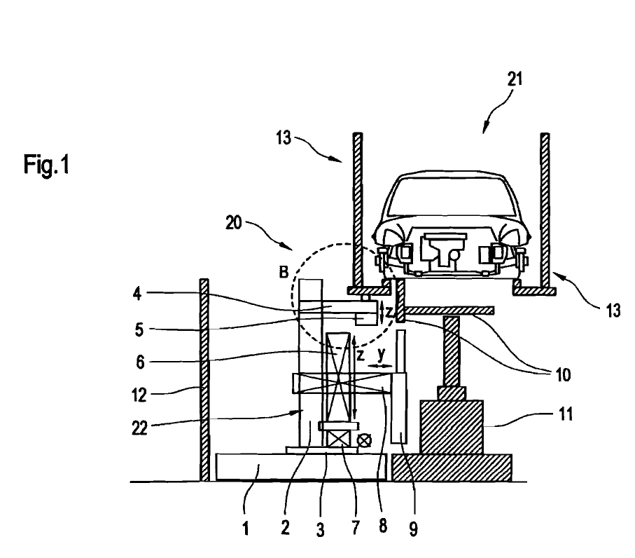

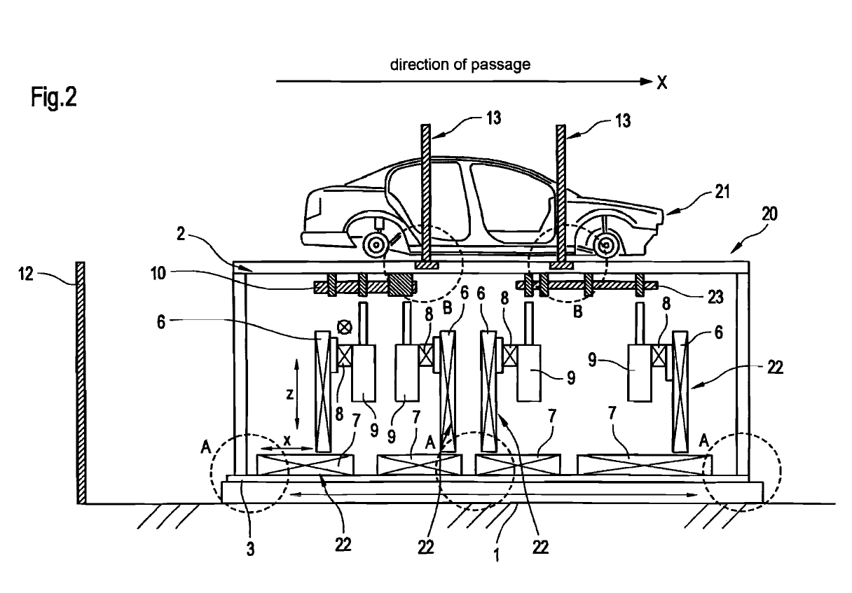

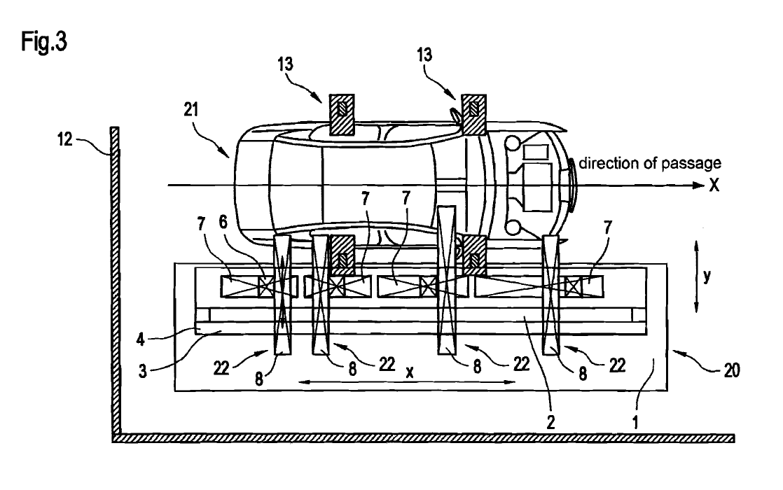

FIGS. 1 to 3 show, behind a protective grid 12, a schematic view of a screw connection station 20 according to the invention. The screw connection station 20 is arranged in the region of a suspension conveyor of which only two of numerous body suspension means 13 can be seen in this view. Placed on the body suspension means 13 is a vehicle body 21, which is moved in the suspension conveyor for finishing.

The screw connection station 20 is divided into a running gear 1, which is formed here by a continuous conveyor, not shown in more detail, over the x-screwing path. The screw connection station 20 travels along with a body within a production station. At the end of the production station the running gear 1 runs with the screw connection station 20 back to the starting point to travel along with the next body.

In a variant not shown, a stop-and-go conveyor may also be used.

A floating plate 3 is provided on the running gear 1 and carries a gantry construction 2, four screw connection devices 22, an assembly stand 11 for the chassis components, not shown here, of the rear axle and a further assembly stand, not shown here, for the chassis components not shown here, of the front axle. The assembly stand 11 engages here on a rear workpiece carrier 10, on which the chassis components, not shown here, of the rear axle are arranged. The other assembly stand engages on a front workpiece carrier 23, on which the chassis components, not shown here, of the front axle are arranged. The floating plate 3 is moveable in the x-direction and in the y-direction.

The front assembly stand and the assembly stand 11 are designed as a unit, which is moved together, in an embodiment not shown here.

Each of the screw connection devices 22 is divided into a z-linear device 6 for displacements in the direction of the z-axis, an x-linear device 7 for displacements in the direction of the x-axis and into a y-linear device 8 for displacements in the direction of the y-axis. One or more EC-screw spindles 9 are arranged on the y-linear device 8 in such a way that they are directed upwardly to the vehicle body 21.

An adaptor displacement unit 4, which engages on a suspension foot 24 of the body suspension means 13, is provided for adaptation or referencing between the body suspension means 13 and the gantry construction 2 or the floating plate 3. A centering displacement unit 5 engages on the suspension foot 24 for a centering between the body suspension means 13 and the gantry construction 2 or the floating plate 3. The adaptation and centering takes place in a manner known per se.

In an embodiment not shown here, a referencing rod construction is provided, which optionally produces a rigid connection or a contact or referencing between the floating plate 3 and a workpiece carrier 10.

The floating plate 3, in a further embodiment, not shown here, may also be mounted on a mounting frame on the running gear 1.

The chassis components are introduced into the vehicle body 21 during the “marriage”. The chassis components are placed on the workpiece carrier 10 or assembly stand 11 in sequence. The assembly stands 11 are in this case driven continuously in a circulating “oval” by an under-floor conveyor.

At the same time, the vehicle body 21 is conveyed synchronously with the assembly stands 11 in the region of the marriage in the body suspension means. In the region of the marriage, the chassis components are then introduced into the vehicle body in that the assembly stands raise the workpiece carriers. The body suspension means 13 are recognised for this purpose and the screw devices 22 travel synchronously with the body suspension means 13. During this, the screw connection devices 22, are located in the waiting position, parallel to the combination.

After the synchronous approaching of the screw connection station 20, the floating plate 3 is referenced with respect to the body suspension means/foot or the assembly plates/assembly stand. In the Figure, the referencing takes place with an auxiliary construction, namely with the gantry construction 2 with respect to the suspension foot. After this, the linear units 6, 7, 8 are moved inwardly to the body.

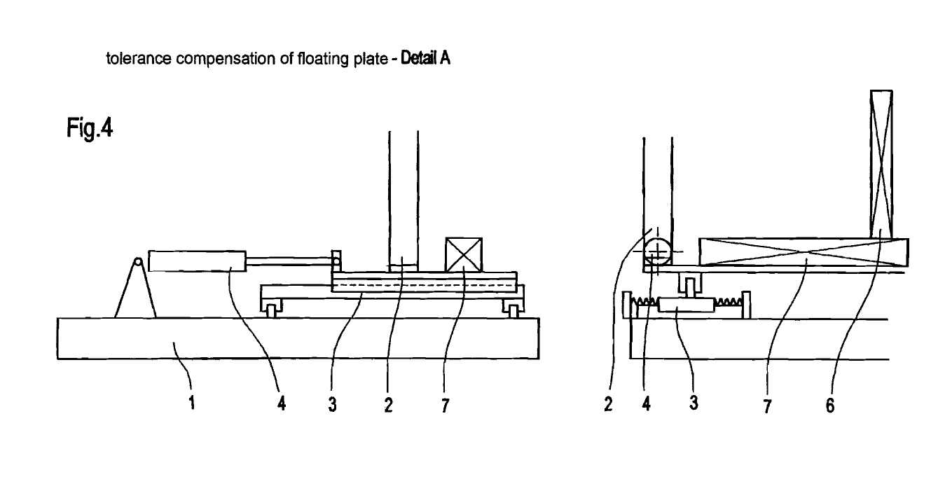

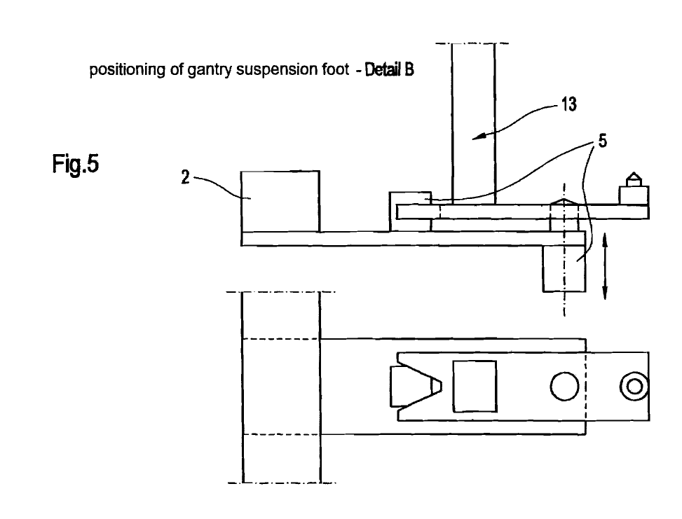

For the tolerance compensation of the floating plates relative to the suspension feet 13, guide units are provided in the x/y-direction, which can best be seen in FIG. 4 for the tolerance compensation relative to the suspension feet. The floating plate 3 extends as necessary over the entire length of the vehicle body 21. The shaping as an inner prism of the suspension foot 24 is used for preliminary positioning and as a stop for the floating plate 3 during referencing to the suspension foot, as can be seen in FIG. 5. In this case, the two suspension feet 23 are used on both sides. The floating plate 3 is then precisely aligned in the receiving holes of all four suspension feet 24, specifically by means of centering cylinders, as can be seen in FIG. 5.

A referencing, not shown here, of the floating plate may also take place with respect to the assembly plates.

A further tolerance compensation in all three spatial directions relative to the intermediate spindles, not shown, on the workpiece carriers can be taken over by the suspension of the screw spindles.

The fastening screw members were inserted manually beforehand in the setting up region in the intermediate spindles provided for this purpose. The screw connection devices 22 then carry out the screw connections automatically.

After the screw connection operation, the referencing of the floating plate 3 with respect to the body suspension means/foot 5 or with respect to the assembly plate 10 is ended. The screw connection station 20 is prepared for the next vehicle body.

FIG. 5 does not show the positioning which is carried out there of the floating plate with respect to the assembly plates.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents.

1. A screw connection station for a suspension conveyor comprising body suspension means for a respective vehicle body and for an assembly device for chassis components to be mounted in the vehicle body, the screw connection station comprising:
a running gear with a floating plate, wherein the running gear is configured as a continuous conveyor which can be moved in an x-direction; and
at least one screw connection device for the floating plate,
wherein the screw connection device is divided into a z-linear device, an x-linear device and a y-linear devices as well as into at least one screw spindle,
wherein a centering-adaptation-displacement unit is provided for temporary connection and referencing between a body suspension means and the floating plate or between an assembly device and the floating plate.

2. The screw connection station according to claim 1, wherein the assembly device is configured as a mounting plate or an assembly stand.

3-11. (canceled)

12. The screw connection station according to claim 1, wherein the running gear is configured as part of a floor conveying system running synchronously with the suspension conveyor.

13. The screw connection station according to claim 1, wherein the floating plate is configured so as to be moveable longitudinally and transversely with respect to the conveying direction.

14. The screw connection station according to claim 1, wherein the centering-adaptation-displacement unit is configured such that it can engage on a suspension foot of the body suspension means.

15. The screw connection station according to claim 1, wherein the centering-adaptation-displacement unit is configured such that it can engage on a mounting plate.

16. The screw connection station according to claim 1, wherein the screw spindle is configured such that a tolerance between the screw spindle and screwing axis can be compensated.

17. The connection station according to claim 1, further comprising at least one axle-type bolt carrier for a manual supply of bolts by means of intermediate spindles on a mounting plate.

18. The screw connection station according to claim 1, wherein an automatic supply of nuts or bolts to the screw spindle is provided.

19. A method for the screw connection of chassis units to a body of a motor vehicle, comprising the steps of:
simultaneous supplying of chassis units to the body of a motor vehicle constantly moved in a continuous process;
alignment of the chassis units with the constantly moved body;
screw connection of the chassis units to the moved body with the aid of a fully automatic screw connection device with at least one linear unit, which is fitted with at least one screw spindle;
detection of the actual values of the screw connection to check and document the screw connection as a quality assurance measure;
further transportation of the body with the connected chassis units; and
evaluation of the detected actual values of the screw connection by a desired/actual comparison with the predetermined screw connection desired data as a further quality assurance measure.

20. The method according to claim 19, wherein the step of simultaneously supplying the chassis units to the body constantly moved in the continuous process comprises the steps of:
supplying the chassis units by means of at least one mounting plate-assembly stand;
supplying the body by means of a suspension conveyor configured as a body suspension means; and
passage through a common production site for the “marriage” or for the joining of the chassis units and body.

21. The method according to claim 20, wherein the screw connection of the chassis units to the moved body comprises the screw spindles with programmable linear units approaching screw points, and the method further comprises the steps of:
detection of the disposition and location of a suspension conveyor moving the body or detection of the disposition and location of a mounting plate-assembly stand moving the chassis units;
start and synchronous travel of a screw connection device with the suspension conveyor and the mounting plate-assembly stand; and
detection of the present screwing situation.

22. The method according to claim 20, wherein the step of screwing the chassis units to the body comprises the steps of:
adjusting the corresponding screw tightening variant;
attaching the screw connection device to the mounting plate-assembly stand or the body suspension means/foot; and
automatic mechanical screwing of the chassis units to the moved body.

23. The method according to claim 20, wherein the step of further transportation of the body with the screw connected chassis units comprises the steps of:
disconnecting the screw connection device;
guiding away the mounting plate-assembly stand;
further transportation of the body; and
displaying the detected actual values of the screw connection operation.

24. The method according to claim 19, wherein the step of evaluation of the detected actual values of the screw connections by a desired/actual comparison with the predetermined screw connection desired data comprises the steps of:
comparison of the installation situation;
storing the evaluation and the detected values;
setting up a report about the evaluation of the screw connection data; and
forwarding the data.
